(19) United States
(12) Patent Application Publication
(10) Pub. No.: US 2022/0034074 A1
(43) Pub. Date: Feb. 3, 2022

(54) Duality Faucet Head

(71) Applicant: Vann Stone Faison, Seattle, WA (US)

(72) Inventor: Vann Stone Faison, Seattle, WA (US)

(21) Appl. No.: 16/945,860

(22) Filed: Aug. 1, 2020

(51) Int. Cl. E03C 1/04; B05B 1/16; B05B 1/20

(52) U.S. Cl. CPC E03C 1/0404; B05B 1/205; B05B 1/1627

(57) ABSTRACT

The present application discloses a faucet head that controls pressure to lock its associated faucet into a fixed position. The basic structure may comprise an inlet, a faucet head body, an outlet and at least one internal water channel. The faucet head may adjust the faucet pressure to allow for the faucet head to become fixed in numerous positions, or to be used as a spray head. The faucet head would allow for a faucet acting in a flexible spray manner to become rigid and fixed in place at a user chosen position. The faucet head would also allow for the user to transform the faucet from fixed position to a flexible spray operation.

The present application relates generally to a faucet head. More specifically, the present application relates to a faucet head that can function in a stationary position and can also function as a movable spray head.

### BACKGROUND

The intended purpose of this section is to provide context to the invention that is stated in the claims. The description herein may include concepts that have the ability to be performed, but have not necessarily been previously performed or conceptualized.

Often, when a user interacts with a faucet head, they are using it as a faucet head that is fixed to the faucet. This faucet head is limited in its function due to it not being able to be used as a spray head and also being secured to the rest of the faucet so that it has predetermined fixed positioning.

In another example, a user may interact with a movable spray head. The spray head may be removed from the end of a faucet body. The spray head will return to a mounting location at the end of the faucet body to be stowed. This example may have the ability to function as a spray head and as a fixed faucet, but it is limited in how many locations it can be be located to be used as a fixed faucet.

In another example, there may be an adjacent mounting hole in one of the faucet mounting surfaces. The spray head may be separate from the faucet head and the two may act independently or as a result of the other.

In another example, a faucet spray head may have buttons to adjust between spray modes. These spray modes are limited to water spray patterns and do not provide a filtration option as well as spray patterns. Additionally, these buttons do not act to change the faucet head from being a rigid faucet head to being a flexible spray head.

In all examples, although the faucet heads and spray heads allow for a free spray or for a fixed directed spray, there is not a duality in abilities provided by the head. This can create hindrances in the use of the sink due to a limited amount of possibilities the faucet head provides.

There is a a need for a new technology that may fix the shortcomings mentioned above.

### SUMMARY OF THE INVENTION

The present application discloses a faucet head that is configured to operate as a movable spray head, as well as a stationary faucet head. With a variety of effects within the faucet head, the faucet head may create an increased back-pressure, a decreased back-pressure, filtered water, an adjustment in the shape of the water leaving the faucet head. The basic structure may comprise an inlet, a faucet head housing, a water outlet, and a faucet state button. The faucet head may allow for the adjustment of the water pressure at the inlet or outlet and may include a water filtration cartridge.

### BRIEF DESCRIPTION OF DRAWINGS

FIG. 1 is an unlabeled perspective view of the duality faucet head.

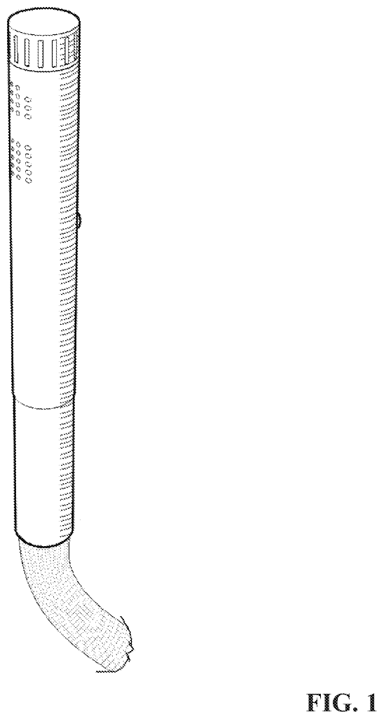

FIG. 2 is a labeled perspective view of the duality faucet head.

FIG. 3 is a cross-sectional view of the inside of a duality faucet head.

FIG. 4 is a cross-sectional view of the inside of a duality faucet head.

FIG. 5 is a cross-sectional view of the inside of a duality faucet head.

### DETAILED DESCRIPTION

Prior to referencing the figures, it should be understood that all features related to particular embodiments, in the Summary above, this Detailed Description, and the Claims below, and in the accompanying Drawings can be used with other features to the extent possible. It should be understood that the current disclosure is not limited by the detail description or illustrations. Additionally, it should be understood that the terminology used is solely for the purpose of description and should not be inferred as limiting.

The present application discloses a faucet head that is capable being used as a stationary faucet head, as well as a movable spray head. Certain applications may require a change in faucet head use from hands-free operation to hands-on spray operation. A faucet head that may function as both a stationary faucet head and a movable spray faucet head may facilitate these applications.

A faucet head that can operate as both a spray head and a stationary faucet head may free up counter space by reducing the amount of fixtures mounted to the counter. With the present invention, a user would only need one faucet head that serves a duality of purposes.

Additional functions that may be advantageous for a duality faucet head are an internal filter that can be changed, as well as spray shape changes such as, direct, mist, centered, dispersed etc. A user may be able to adjust the faucet head function to direct water through a filter. A user could easily switch the filter capability to reconfigure from filtered to non-filtered as the user needs Similarly, a user may be able to direct water through a spray shapes as the user needs.

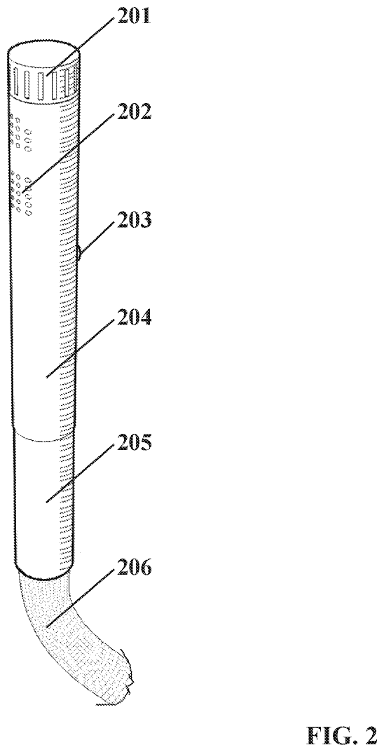

The present application discloses a faucet head that can function as a moveable faucet spray head and a stationary faucet head. The basic structure is represented in FIG. 2. The faucet head may comprise a faucet top, shown on FIG. 2 as 201, which may contain a spray mode adjustment valve. Water outlet, shown in FIG. 2 as 202, may allow for the water to exit the faucet head. A state change button, shown in FIG. 2 as 203. The state change button may be a diverter valve that allows the water to bypass an internal crack valve, water pressure release valve etc. A faucet head housing represented as number 204 in FIG. 2. A filter, shown in FIG. 2 as 205. The filter may be a carbon filter, or other water filter and may be exchangeable. A water inlet, shown in FIG.2 as 206 may connect the faucet head to the rest of the faucet, faucet mounting surface or faucet valve. In some embodiments, the faucet head may have more than one state change buttons that can serve a press and release function. In other embodiments, the faucet head may have only one state change button that serves a press and hold function. The diverters and valves and the faucet head water initiation may be served due to an electronic stimulus or automatic faucet sensor. Additionally, he diverters and valves may serve as initiators to electronic stimulus.

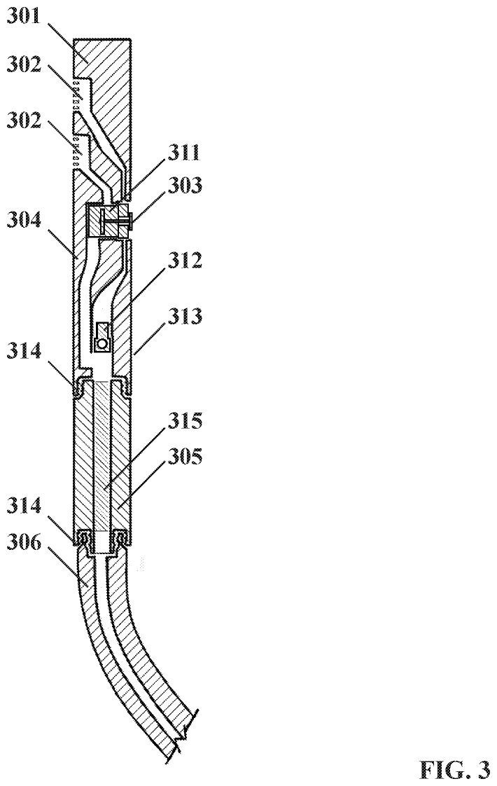

A cross-sectional view in FIG. 3 shows an exemplary embodiment of the faucet head. The water outlets shown as 302 may have channels that connect them to at least one diverter valve shown as 303 in FIG. 3, release valve or crack valve shown as 312 in FIG. 3. The water outlets may be separate from or connected to each other. The state change button 303 may control the adjustment of the diverter valve shown as 311. This may allow water to leave the faucet head or may prevent water from leaving the faucet head. The faucet head may have a crack valve, pressure relief valve etc, that retains releases water once a predetermined pressure is achieved (ie, 45 psi, 50 psi, etc). The crack valve is shown as 312 in FIG. 3. Diverter valve 311 may operate as a manual or automatic override valve to crack valve 312. The faucet head housing represented by 304 may have an external aesthetic cover shown as 313. The filter shown as 315 in FIG. 3, may be exchangeable. This may be achieved by a exchangeable segment of the faucet head, shown in FIG. 3 as 305 and may be a filter and may be located between the water inlet coming from faucet body 306 and diverter valve 311 and crack valve 312 or may be located between diverter valve 311 and crack valve 312 and water outlets 302. When included, filter 305 is intended to allow the faucet head user to obtain filtered water and to easily replace the filter when necessary. The filter, 305, and faucet assembly may be threaded, or pressure fitted, shown at connection joint 314.

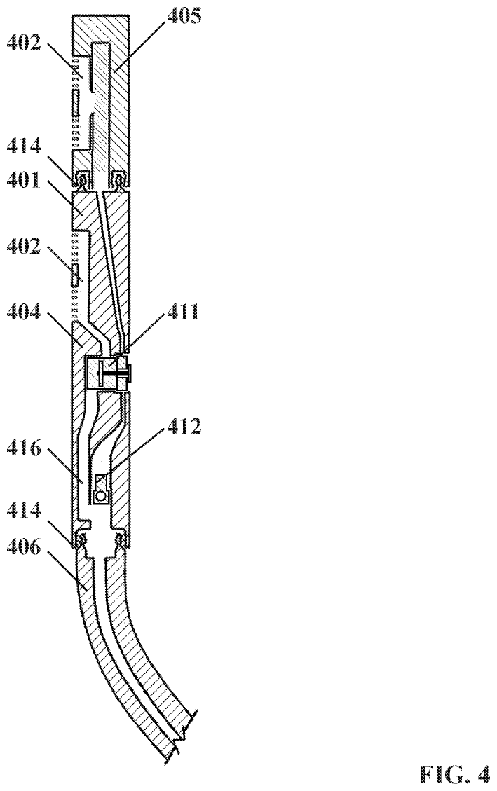

A cross-sectional view in FIG. 4 is an exemplary embodiment showing the filter, 405, located after the diverter valve 411 and crack valve 412 and before the water outlet 402. Positioning the filter, 405, after diverter valve 411 may allow for easier replacement of the filter. FIG. 4 also exemplifies water outlet channels 402 as being connected and not independent of each-other. The filtered water may come from water traveling through either the crack valve shown as 412 in FIG. 4, or through the bypass channel shown as 416 in FIG. 4. The diverter valve 411 may control the water from either the crack valve 412 or the bypass channel 416. There may be multiple diverters and there may be multiple crack valves in an embodiment. Connection joint 414 may be positioned to allow for the filter to connect to the faucet top, 401. Faucet body 404 may connect to water inlet 406.

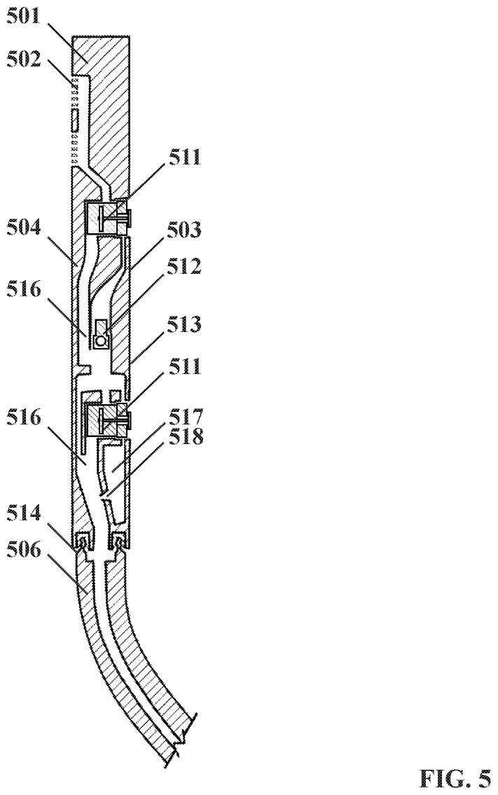

A cross-sectional view in FIG. 5 may include a water pressure release reservoir shown as 517. One or more valves, 511, may divert water into the water pressure release reservoir to contain excess water. The reservoir may be emptied as a result of using the faucet head or as a manual override to the faucet head. The reservoir may have a valve, 518, that allows for the reservoir to be emptied as an effect to the function of the faucet. The reservoir 517 may feed to an internal channel or may feed to a diverter. In an alternative embodiment, the reservoir may be external to the faucet head. There may be multiple diverter valves 511 and crack valves 512 depending on the configuration of the head and desired functions (ie; mist, jet etc.). The filter component may be omitted for a filterless option as illustrated in this embodiment. Water outlet 502 and water inlet 506 may move water to some or all of the valves 512 and diverters 511. There may be more than one bypass channel, 516.

In some embodiments, the faucet head may dock into a magnetic dock. This dock may have a spring and magnetic mechanism to allow for the faucet head to be extended or recessed into the dock. The faucet head may have formal variation in the body, or aesthetic cover, or may have magnets to allow for magnetic docking.

1. A Faucet head that functions as both a stationary faucet head and a movable spray faucet head due to non-simultaneous operation of the same.

2. A Faucet head that enables a sink faucet to function as a stationary faucet and as a movable spray faucet.

3. A Faucet head which enables faucet positioning by maintaining various pressure states and positions as a result of fluid pressure.

4. The faucet head of claim 1 wherein the faucet head has a replaceable water filter.

5. The faucet head of claim 1 wherein the faucet head has a spring activated magnetic docking mechanism.

6. The faucet head of claim 1 wherein the faucet head has an internal reservoir for water pressure release.

7. The faucet head of claim 1 which has an outlet for an external reservoir for water pressure release.

8. The faucet head of claim 1 which has multiple spray functions.

9. The faucet head of claim 1 which is docked through the faucet mounting hole.

10. The faucet head of claim 2 wherein the faucet head has a replaceable water filter.

11. The faucet head of claim 2 wherein the faucet head has a spring activated magnetic docking mechanism.

12. The faucet head of claim 2, wherein the faucet head has an internal reservoir for water pressure release.

13. The faucet head of claim 2, which has an outlet for an external reservoir for water pressure release.

14. The faucet head of claim 2, which has multiple spray functions.

15. The faucet head of claim 2, which is docked through the faucet mounting hole.

16. The faucet head of claim 3, wherein the faucet head has a replaceable water filter.

17. The faucet head of claim 3, wherein the faucet head has a spring activated magnetic docking mechanism.

18. The faucet head of claim 3, wherein the faucet head has an internal reservoir for water pressure release.

19. The faucet head of claim 3, which has an outlet for an external reservoir for water pressure release.

20. The faucet head of claim 3, which has multiple spray functions.

21. The faucet head of claim 3, which is docked through the faucet mounting hole.
